(19) United States
(12) Patent Application Publication
(10) Pub. No.: US 2023/0026276 A1
(43) Pub. Date: Jan. 26, 2023

(54) PROJECTION DEVICE

(71) Applicant: IVIEW DISPLAYS (SHENZHEN) COMPANY LTD., Shenzhen (CN)

(72) Inventors: Mingnei Ding, Shenzhen (CN); Steve Yeung, HongKong (CN); Zhiqiang Gao, HongKong (CN); Xiang Li, Shenzhen (CN)

(21) Appl. No.: 17/866,611

(22) Filed: Jul. 18, 2022

(30) Foreign Application Priority Data
Jul. 19, 2021 (CN) 202110812970.1

(51) Int. Cl. G03B 21/14; G03B 21/54

(52) U.S. Cl. CPC G03B 21/145; G03B 21/54

(57) ABSTRACT

Embodiments of the present disclosure, relating to the technical field of projection and display, provide a projection device. The projection device includes a projecting unit, a dust-proof device, and an adjusting unit. The dust-proof device includes a housing, a first light-transmissive plate, and a second light-transmissive plate. The housing is provided with a receiving chamber. The projecting unit is disposed in the dust-proof device, and the dust-proof device achieves a dust-proof function for the projecting unit. In addition, part of the projection light beam of the projecting unit may be emitted from the first light-transmissive plate of the dust-proof device to achieve projection in a first direction, and may be emitted from the second light-transmissive plate to achieve projection in a second direction. The adjusting unit disposed on the dust-proof device may adjust the projection direction of the projection light beam emitted from the second light-transmissive plate to enlarge a projection range in the second direction. According to the embodiments of the present disclosure, multi-direction projection and dust-proofing are implemented.

### TECHNICAL FIELD

Embodiments of the present disclosure relate to the technical field of projection and display, and in particular, relate to a projection device.

### BACKGROUND

With the rapid development of the semiconductor display technologies, various portable electronic devices are being continuously designed and manufactured. Wide application of the portable electronic devices pushes requirements of the users on display devices to develop towards miniaturization, high resolution, and movability. Under such intense demands, projection technologies have got rapid development, and varieties of small-size and high-performance portable projectors have been placed into the market. At present, various application scenarios need motion projection, such as families, large-scale stages, and the like. A projection device needs to multi-directionally project images according to a user instruction, and needs to be synchronized with projection content, such that an immersive experience is created by combining motion with content.

However, during practice of the present disclosure, the inventors have found that the conventional multi-direction projection scheme is not mature, and in such schemes, the projection devices are mostly exposed outside and are easily subject to dust, and thus a display effect of a projection screen is affected.

### SUMMARY

In view of the above technical problem, embodiments of the present disclosure provide a projection device, which is capable of implementing multi-direction projection and dust-proofing.

To solve the above technical problem, the embodiments of the present disclosure provide a technical solution of a projection device. The projection device includes a projecting unit, a dust-proof device, and an adjusting unit. The projecting unit is configured to project a projection light beam, wherein the projection light beam covers a predetermined range. The dust-proof device includes a housing, a first light-transmissive plate, and a second light-transmissive plate, wherein the housing is provided with a receiving chamber, a top portion of the housing is provided with a first opening in communication with the receiving chamber, a side wall of the housing is provided with a second opening in communication with the receiving chamber, the first light-transmissive plate covers the first opening, the second light-transmissive plate covers the second opening, the projecting unit is disposed in the receiving chamber, part of the projection light beam of the projecting unit passes through the first light-transmissive plate and is emitted out of the dust-proof device, and part of the projection light beam of the projecting unit passes through the second light-transmissive plate and is emitted out of the dust-proof device. The adjusting unit is disposed on the dust-proof device, and rotatable with respect to the dust-proof device, wherein in the case that the adjusting unit rotates towards a direction going away from the dust-proof device, the adjusting unit is capable of adjusting a projection direction of the part of the projection light beam passing through the second light-transmissive plate.

Optionally, the adjusting unit includes a reflective mirror; wherein the reflective mirror is rotatably disposed on the dust-proof device.

Optionally, the adjusting unit further includes a first drive device; wherein the first drive device is disposed on the dust-proof device and connected to the reflective mirror, and the first drive device is configured to drive the reflective mirror to rotate with respect to the dust-proof device.

Optionally, the second light-transmissive plate is provided with a window; wherein the first drive device is capable of driving the reflective mirror to rotate and cover the window.

Optionally, the first drive device is a motor.

Optionally, the projection device further includes a turntable; wherein the dust-proof device is rotatably connected to the turntable.

Optionally, the projection device further includes a second drive device; wherein the second drive device is connected to the dust-proof device, and the second drive device is configured to drive the dust-proof device to rotate with respect to the turntable.

Optionally, the projection device further includes a base and a third drive device; wherein the base is connected to the turntable, the third drive device is connected to the turntable, and the third drive device is configured to drive the turntable to rotate with respect to the base.

Optionally, the projection device further includes a first position sensor; wherein the first position sensor is configured to detect a rotation angle of the reflective mirror with respect to the dust-proof device.

Optionally, the projection device further includes a controller; wherein the controller is connected to the adjusting unit, and the controller is configured to control the adjusting unit to rotate.

The embodiments of the present disclosure achieve the following beneficial effects: In the projection device according to the embodiments of the present disclosure, the projecting unit is disposed in the dust-proof device, and the dust-proof device achieves a dust-proof function for the projecting unit. In addition, part of the projection light beam of the projecting unit may be emitted from the first light-transmissive plate of the dust-proof device to achieve projection in a first direction, and may be emitted from the second light-transmissive plate to achieve projection in a second direction. The adjusting unit disposed on the dust-proof device may adjust the projection direction of the projection light beam emitted from the second light-transmissive plate to enlarge a projection range in the second direction. Therefore, the projection device is capable of implementing multi-direction projection and dust-proofing.

### BRIEF DESCRIPTION OF THE DRAWINGS

For clearer descriptions of the technical solutions according to the specific embodiments of the present disclosure or the technical solutions in the related art, the accompanying drawings incorporated for illustrating the specific embodiments or the related art are briefly described hereinafter. In all the accompanying drawings, like elements or parts are generally denoted by like reference numerals.

FIG. 1 is a schematic view of a projection device according to an embodiment of the present disclosure;

FIG. 2 is a schematic exploded view of the projection device according to an embodiment of the present disclosure; and

FIG. 3 is a schematic exploded view of the projection device from another angle according to an embodiment of the present disclosure.

Reference numerals and denotations thereof:

| | | | |
|---|---|---|---|
| 100 | projection device | 32 | reflective mirror |
| 10 | projecting unit | 34 | first drive device |
| 20 | dust-proof device | 40 | turntable |
| 22 | housing | 50 | base |
| 222 | receiving chamber | 60 | second drive device |
| 24 | first light-transmissive plate | 70 | third drive device |
| 26 | second light-transmissive plate | 80 | roller |
| 30 | adjusting unit | | |

### DETAILED DESCRIPTION

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. As used herein, the terms “vertical,” “horizontal,” “left,” “right,” and similar expressions are for illustration purposes.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

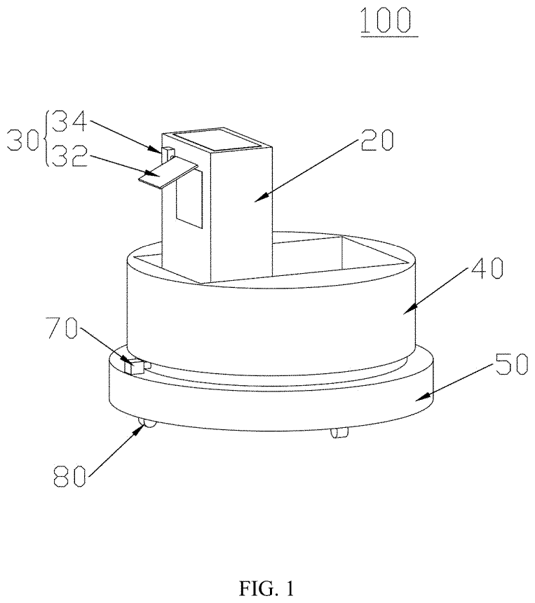

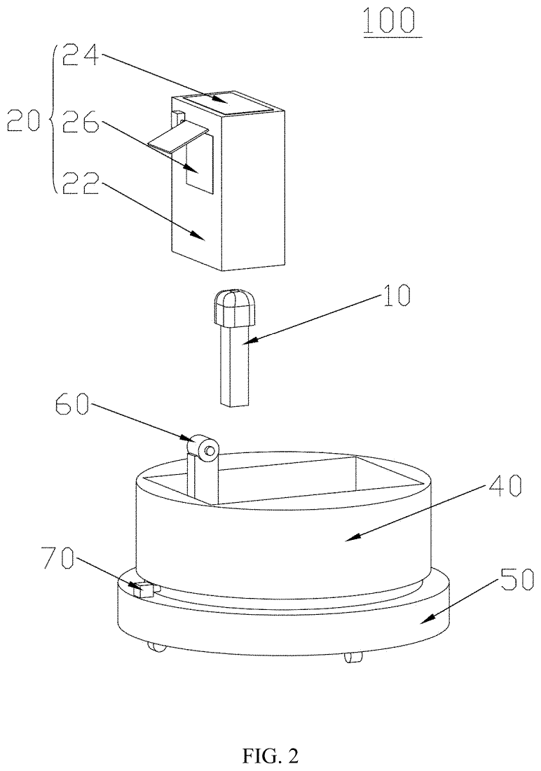

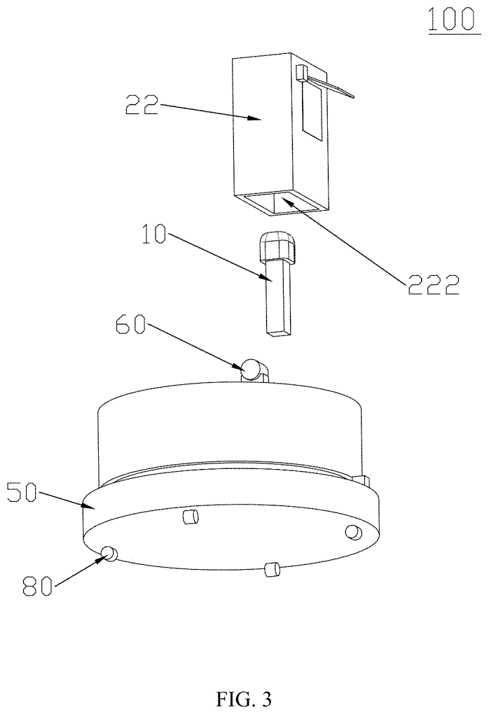

With reference to FIG. 1, FIG. 2, and FIG. 3, description is given hereinafter.

A projection device 100 includes a projecting unit 10, a dust-proof device 20, an adjusting unit 30, a turntable 40, and a base 50. The projecting unit 10 is disposed in the dust-proof device 20. The dust-proof device 20 is disposed on the turntable 40. The turntable 40 is disposed on the base 50. The adjusting unit 30 is disposed on the dust-proof device 20. The projecting unit 10 is configured to project a projection light beam. The adjusting unit 30 is configured to adjust a projection direction of the projection light beam projected by the projecting unit 10. The dust-proof device 20 is configured to proof dust. The projecting unit 10 has a specific projection range, and is capable of achieving projections in a vertical upward direction and a horizontal direction.

The dust-proof device 20 includes a housing 22, a first light-transmissive plate 24, and a second light-transmissive plate 26. The housing 22 is provided with a receiving chamber 222, a top portion of the housing 22 is provided with a first opening in communication with the receiving chamber 222, and a side wall of the housing 22 is provided with a second opening in communication with the receiving chamber 222. The first light-transmissive plate 24 covers the first opening. The second light-transmissive plate 26 covers the second opening. The receiving chamber 222 is configured to receive the projecting unit 10. Part of the projection light beam of the projecting unit 10 passes through the first light-transmissive plate 24 and is emitted out of the dust-proof device 20, and part of the projection light beam of the projecting unit 10 passes through the second light-transmissive plate 26 and is emitted out of the dust-proof device 20, such that projections in two directions are achieved.

The adjusting unit 30 includes a reflective mirror 32 and a first drive device 34. The reflective mirror 32 is rotatably disposed on the dust-proof device 20, and is openable outward with respect to the dust-proof device 20, and the reflectively mirror 32 is disposed opposite to the second light-transmissive plate 26 of the dust-proof device 20 and configured to reflect a projection screen to a target projection position. The first drive device 34 is disposed on an outer surface of the dust-proof device 20, and is connected to the reflective mirror 32 and configured to drive the reflective mirror 32 to rotate with respect to the dust-proof device 20 to adjust a projection direction of the projection light beam emitted from the second light-transmissive plate 26.

In some embodiments, the second light-transmissive plate 26 of the dust-proof device 20 is provided with a window (not illustrated), and the first drive device 34 is capable of driving the reflective mirror 32 to rotate and cover the window of the second light-transmissive plate 26.

The turntable 40 is disposed on the base 50, and rotatably connected to the dust-proof device 20. The dust-proof device 20 is rotatable within a vertical range with respect to the turntable 40.

In some embodiments, the projection device 100 further includes a second drive device 60. The second drive device 60 is disposed on the turntable 40, and is connected to the dust-proof device 20. The second drive device 60 is configured to drive the dust-proof device 20 to rotate with respect to the turntable 40. In this way, projection directions of the projection light beams emitted from the first light-transmissive plate 24 and the second light-transmissive plate 26 in a vertical plane are adjusted.

In some embodiments, the projection device 100 further includes a third drive device 70. The third drive device 70 is disposed on the base 50, and is connected to the turntable 40. The third drive device 70 is configured to drive the turntable 40 to rotate with respect to the base 50. In this way, the projection directions of the projection light beams emitted from the first light-transmissive plate 24 and the second light-transmissive plate 26 in a horizontal plane are adjusted.

In some embodiments, the first drive device 34, the second drive device 60, and the third drive device 70 are all motors, and are stepping motors.

In some embodiments, the projection device 100 further includes a controller (not illustrated). The controller may be disposed on the base 50, or may be disposed on the turntable 40 or the dust-proof device 20. The controller is communicably connected to the first drive device 34, the second drive device 60, and the third drive device 70. The controller is configured to control a rotation angle of the reflective mirror 32 with respect to the dust-proof device 20, a rotation angle of the dust-proof device 20 with respect to the turntable 40, and a rotation angle of the turntable 40 with respect to the base 50.

In some embodiments, a bottom of the base 50 is provided with a roller 50 and a fourth drive device (not illustrated). The roller 80 is rotatable by 360 degrees, and the controller controls the fourth drive device to drive the roller 80 to rotate.

In some embodiments, the projection device 100 further includes a first position sensor (not illustrated), a second position sensor (not illustrated), and a third position sensor (not illustrated). The first position sensor is disposed on the first drive device 34, the second position sensor is disposed on the second drive device 60, and the third position sensor is disposed on the third drive device 70. The first position sensor is configured to detect the rotation angle of the reflective mirror 32 with respect to the dust-proof device 20, the second position sensor is configured to detect the rotation angle of the dust-proof device 20 with respect to the turntable 40, and the third position sensor is configured to detect the rotation angle of the turntable 40 with respect to the base 50.

In the embodiments, the first position sensor, the second position sensor, and the third position sensor are all angular displacement sensors, and further, may be capacitive sensors with high sensitivity to measure variations of angular displacement amounts of the first drive device 34, the second drive device 50, and the third drive device 70, which are sensing devices capable of converting the measured angular displacements caused by rotation of shaft into electric signals based on capacitance variations.

In the embodiments, the reflective mirror 32 may be opened outward with respect to the dust-proof device 20, such that the projection light beam emitted from the second light-transmissive plate 26 is reflected to a range of 90 degrees between the ground and a horizontal direction. The dust-proof device 20 may rotate by 90 degrees in a vertical direction with respect to the turntable 40, and thus in combination with a projection angle from the second light-transmissive plate 26 and an upward projection angle from the first light-transmissive plate 24, 0 to 360 degrees projection within the vertical direction may be achieved. In addition, the turntable 40 may rotate by 360 degrees in the horizontal direction with respect to the base 50. Therefore, the projection device 100 is capable of achieving global space projection.

In the projection device 100 according to the embodiments of the present disclosure, the projecting unit 10 is disposed in the dust-proof device 20, and the dust-proof device 20 achieves a dust-proof function for the projecting unit 10. In addition, part of the projection light beam of the projecting unit 10 may be emitted from the first light-transmissive plate 24 of the dust-proof device 20 to achieve projection in a first direction, and may be emitted from the second light-transmissive plate 26 to achieve projection in a second direction. The adjusting unit 30 disposed on the dust-proof device 20 may adjust the projection direction of the projection light beam emitted from the second light-transmissive plate 26 to enlarge a projection range in the second direction. Therefore, the projection device 100 is capable of implementing multi-direction projection and dust-proofing.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

1. A projection device, comprising:
a projecting unit, configured to project a projection light beam, wherein the projection light beam covers a predetermined range;
a dust-proof device, comprising a housing, a first light-transmissive plate, and a second light-transmissive plate, wherein the housing is provided with a receiving chamber, a top portion of the housing is provided with a first opening in communication with the receiving chamber, a side wall of the housing is provided with a second opening in communication with the receiving chamber, the first light-transmissive plate covers the first opening, the second light-transmissive plate covers the second opening, the projecting unit is disposed in the receiving chamber, part of the projection light beam of the projecting unit passes through the first light-transmissive plate and is emitted out of the dust-proof device, and part of the projection light beam of the projecting unit passes through the second light-transmissive plate and is emitted out of the dust-proof device; and
an adjusting unit, disposed on the dust-proof device, and rotatable with respect to the dust-proof device, wherein in the case that the adjusting unit rotates towards a direction going away from the dust-proof device, the adjusting unit is capable of adjusting a projection direction of the part of the projection light beam passing through the second light-transmissive plate.

2. The projection device according to claim 1, wherein the adjusting unit comprises a reflective mirror; wherein the reflective mirror is rotatably disposed on the dust-proof device.

3. The projection device according to claim 2, wherein the adjusting unit further comprises a first drive device; wherein the first drive device is disposed on the dust-proof device and connected to the reflective mirror, and the first drive device is configured to drive the reflective mirror to rotate with respect to the dust-proof device.

4. The projection device according to claim 3, wherein the second light-transmissive plate is provided with a window; wherein the first drive device is capable of driving the reflective mirror to rotate and cover the window.

5. The projection device according to claim 3, wherein the first drive device is a motor.

6. The projection device according to claim 5, further comprising a turntable; wherein the dust-proof device is rotatably connected to the turntable.

7. The projection device according to claim 6, further comprising a second drive device; wherein the second drive device is connected to the dust-proof device, and the second drive device is configured to drive the dust-proof device to rotate with respect to the turntable.

8. The projection device according to claim 7, further comprising a base and a third drive device; wherein the base is connected to the turntable, the third drive device is connected to the turntable, and the third drive device is configured to drive the turntable to rotate with respect to the base.

9. The projection device according to claim 8, further comprising a first position sensor; wherein the first position sensor is configured to detect a rotation angle of the reflective mirror with respect to the dust-proof device.

10. The projection device according to claim 9, further comprising a controller; wherein the controller is connected to the adjusting unit, and the controller is configured to control the adjusting unit to rotate.
